(19) United States
(12) Patent Application Publication
(10) Pub. No.: US 2023/0385613 A1
(43) Pub. Date: Nov. 30, 2023

(54) Machine-Learned Discretization Level Reduction

(71) Applicant: Google LLC, Mountain View, CA (US)

(72) Inventor: Shumeet Baluja, Leesburgh, VA (US)

(21) Appl. No.: 18/249,389

(22) PCT Filed: Oct. 29, 2020
(86) PCT No.: PCT/US2020/057974

§ 371 Date: Apr. 18, 2023

(51) Int. Cl. G06N 3/048

(52) U.S. Cl. CPC G06N 3/048

(57) ABSTRACT

A computer-implemented method for providing level-reduced tensor data having improved representation of information can include obtaining input tensor data, providing the input tensor data as input to a machine-learned discretization level reduction model configured to receive tensor data having a number of discretization levels and produce, in response to receiving the tensor data, level-reduced tensor data having a reduced number of discretization levels, and obtaining, from the machine-learned discretization level reduction model, the level-reduced tensor data. The machine-learned discretization level reduction model is trained using reconstructed input tensor data generated using an output of the machine-learned discretization level reduction model. The machine-learned discretization level reduction model can include one or more level reduction layers configured to receive input having a first number of discretization levels and to provide a layer output having a reduced a number of discretization levels.

### FIELD

The present disclosure relates generally to systems and methods for binarization and/or other bit-reduction of tensor data, such as images. More particularly, the present disclosure relates to machine-learned models that produce output tensor data having a reduced number of discretization levels (e.g., to retain and match color information while compressing color images to black and white).

### BACKGROUND

Tensors can hold structured data. The data within a tensor may have a number of discretization levels associated therewith. As one example, images can be represented as discrete tensors having varying intensity levels. As one example, images can be represented by combinations of channels. For example, an image can be represented as a combination of various channels each corresponding to a color, hue, intensity, etc. For example, some images can be represented as a tensor having a red channel, a blue channel, and a green channel having varying intensity levels at each channel corresponding to an intensity of the respective color at a point in the tensor. Display screens and other systems can display information, such as images, based on the tensor.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for providing level-reduced tensor data having improved representation of information. The computer-implemented method can include obtaining input tensor data. The computer-implemented method can include providing the input tensor data as input to a machine-learned discretization level reduction model configured to receive tensor data having a number of discretization levels and produce, in response to receiving the tensor data, level-reduced tensor data having a reduced number of discretization levels. The machine-learned discretization level reduction model can include at least one input layer configured to receive the tensor data and one or more level reduction layers connected to the at least one input layer, the one or more level reduction layers configured to receive input having a first number of discretization levels and to provide a layer output having a reduced a number of discretization levels, wherein each level reduction layer is associated with a respective number of discretization levels and the discretization level is reduced at each layer of the one or more level reduction layers based at least in part on a discretized activation function having the respective number of discretization levels associated with the level reduction layer. The computer-implemented method can include obtaining, from the machine-learned discretization level reduction model, the level-reduced tensor data. The machine-learned discretization level reduction model is trained using reconstructed input tensor data generated using an output of the machine-learned discretization level reduction model.

Another example aspect of the present disclosure is directed to a computer-implemented method for training a discretization level reduction model to provide level-reduced tensor data having improved representation of information. The computer-implemented method can include obtaining, by a computing system including one or more computing devices, training data, the training data including input tensor data. The computer-implemented method can include providing, by the computing system, the training data to a discretization level reduction model, the discretization level reduction model configured to receive tensor data including a number of discretization levels and produce, in response to receiving the tensor data, level-reduced tensor data having a reduced number of discretization levels. The computer-implemented method can include determining, by the computing system and based at least in part on the discretization level reduction model, the level-reduced tensor data. The computer-implemented method can include determining, by the computing system and based at least in part on the discretization level reduction model, reconstructed input tensor data based at least in part on the level-reduced tensor data. The computer-implemented method can include determining, by the computing system, a loss based at least in part on the input tensor data and the reconstructed input tensor data. The computer-implemented method can include adjusting, by the computing system, one or more parameters of the discretization level reduction model based at least in part on the loss.

Another example aspect of the present disclosure is directed to one or more non-transitory, computer-readable media storing a machine-learned discretization level reduction model configured to receive tensor data including a number of discretization levels and produce, in response to receiving the tensor data, level-reduced tensor data including a reduced number of discretization levels. The machine-learned discretization level reduction model can include at least one input layer configured to receive the tensor data and a plurality of level reduction layers connected to the at least one input layer, the plurality of level reduction layers configured to progressively and monotonically reduce a number of discretization levels at each of the plurality of level reduction layers.

In an example described herein, a machine-learned discretization level reduction model is provided. The machine-learned discretization level reduction model is configured to receive tensor data having a number of discretization levels and produce, in response to receiving the tensor data, level-reduced tensor data having a reduced number of discretization levels.

The machine-learned discretization level reduction model may be trained using reconstructed input tensor data generated using an output of the machine-learned discretization level reduction model. The machine-learned discretization level reduction model may be stored on one or more non-transitory computer-readable storage media.

The machine-learned discretization level reduction model may include at least one input layer configured to receive the tensor data; and one or more level reduction layers connected to the at least one input layer, the one or more level reduction layers configured to receive input having a first number of discretization levels and to provide a layer output having a reduced a number of discretization levels.

Each level reduction layer may be associated with a respective number of discretization levels and the discretization level may be reduced at each layer of the one or more level reduction layers based at least in part on a discretized activation function having the respective number of discretization levels associated with the level reduction layer. The discretized activation function may be a tanh function.

The one or more level reduction layers may each be configured to reduce the number of discretization levels based at least in part on a scaling factor. For example, the scaling factor may be one half.

The one or more level reduction layers may progressively and monotonically reduce a number of discretization levels at each of the one or more level reduction layers.

The discretization level reduction model may include at least one feature representation layer configured to map the input tensor data from the input layer to a feature representation of the input tensor data.

The discretization level reduction model may include at least one channel reduction layer configured to reduce an input to the at least one channel reduction layer input data having a first number of channels to an output of the at least one channel reduction layer having a reduced number of channels.

The machine-learned discretization level reduction model may include an output layer configured to provide the level-reduced tensor data.

The machine-learned discretization level reduction model may include one or more reconstruction layers configured to reconstruct reconstructed input tensor data from the level-reduced tensor data.

The discretization level reduction model includes a color bypass network. The color bypass network may include one or more fully connected hidden units. For example, the color bypass network may include between one and ten fully connected hidden units.

According to an example described herein, there is a computer-implemented method for using the machine-learned discretization level reduction model for providing level-reduced tensor data having improved representation of information. The method includes: obtaining input tensor data; providing the input tensor data as input to the machine-learned discretization level reduction model; obtaining, from the machine-learned discretization level reduction model, the level-reduced tensor data.

According to another example described herein, there is a computer-implemented method for training the discretization level reduction model to provide level-reduced tensor data having improved representation of information. The method includes obtaining training data, the training data including input tensor data; providing the training data to the discretization level reduction model; determining, based at least in part on the discretization level reduction model, the level-reduced tensor data; determining, based at least in part on the discretization level reduction model, reconstructed input tensor data based at least in part on the level-reduced tensor data; determining a loss based at least in part on the input tensor data and the reconstructed input tensor data; and adjusting one or more parameters of the discretization level reduction model based at least in part on the loss.

The loss may include a pixel-wise difference between the input tensor data and the reconstructed input tensor data.

Where the discretization level reduction model includes a color bypass network, determining reconstructed input tensor data based at least in part on the level-reduced tensor data may include: obtaining a first reconstructed input tensor data component from the one or more reconstruction layers, the first reconstructed input tensor data component based at least in part on the level-reduced tensor data; obtaining a second reconstructed input tensor data component from the color bypass network, the second reconstructed input tensor data component based at least in part on the input tensor data; and determining the reconstructed input tensor data based at least in part on the first reconstructed input tensor data component and the second reconstructed input data component.

The first reconstructed input tensor data component may include a reconstructed image and the second reconstructed input tensor data component may include a color tint for the reconstructed image.

In the method for using or the method for training the machine-learned discretization level reduction model the input tensor data includes image data, and wherein the level-reduced tensor data includes binarized image data.

The reduced number of discretization levels of the level-reduced tensor data is two discretization levels

According to another example described herein, a system includes one or more processors and one or more computer-readable memory devices storing instructions that, when implemented, cause the one or more processors to perform any of the methods set out above or below.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of implementations directed to one of ordinary skill in the art is set forth in the specification, which makes reference to the appended figures, in which:

FIG. 1A depicts a block diagram of an example computing system that performs discretization level reduction according to example implementations of the present disclosure.

FIG. 1B depicts a block diagram of an example computing device that performs discretization level reduction according to example implementations of the present disclosure.

FIG. 1C depicts a block diagram of an example computing device that performs discretization level reduction according to example implementations of the present disclosure.

FIG. 2 depicts a block diagram of an example discretization level reduction system according to example implementations of the present disclosure.

FIG. 3 depicts a block diagram of an example discretization level reduction model according to example implementations of the present disclosure.

FIG. 4 depicts a block diagram of an example discretization level reduction model according to example implementations of the present disclosure.

FIG. 5 depicts a block diagram of an example discretization level reduction model according to example implementations of the present disclosure.

FIGS. 6A, 6B, 6C, and 6D depict example discretized activation functions according to example implementations of the present disclosure.

FIG. 7 depicts a flow chart diagram of an example computer-implemented method for providing level-reduced tensor data having improved representation of visual information according to example implementations of the present disclosure.

FIG. 8 depicts a flow chart diagram of an example computer-implemented method for training a discretization level reduction model to provide level-reduced tensor data having improved representation of visual information according to example implementations of the present disclosure.

Reference numerals that are repeated across plural figures are intended to identify the same features in various implementations.

### DETAILED DESCRIPTION

Generally, the present disclosure is directed to systems and methods for binarization and/or other bit-reduction of tensor data, such as visual or otherwise displayable tensor data, such as images (e.g., two-dimensional images). Binarization refers to converting discretized tensor data having a plurality of discretization levels (e.g., 24 bits per level) to tensor data having only two discretization levels (e.g., 0 and 1, such as a black and white or bitonal image). Furthermore, the tensor data may be converted from having a plurality of channels (e.g., color channels) to tensor data having a single channel. As one example, the original (e.g., input) tensor data may be or include RGB image data having 256 (e.g., 8 bits) discretization levels and the level-reduced (e.g., output) tensor data may be bitonal (e.g., black and white) image data having a single channel with two discretization levels, corresponding to bitonal pixel levels (e.g., black and white, shaded and not shaded, etc.). Example aspects of the present disclosure can be generalized to any suitable level-reduction, such as reducing tensor data to four discretization levels (e.g., two bits), eight discretization levels (e.g., three bits), etc.

As one example, bit-reduction of tensor data can be useful in situations where a medium intended to display or otherwise utilize the tensor data cannot (e.g., due to structural and/or other limitations) convey enough information to accurately represent the tensor data. For example, a two-color display screen, such as included in an e-reader or e-ink system, may be incapable of displaying an RGB image, as the pixels of the display may be limited to two colors (e.g., shaded/lit and not shaded/lit). As another example, a printer may be configured to print black and white images, such as for newspaper printing, bulk printing, photocopies, etc. As another example, subtractive construction systems such as CNC machines, laser etching, etc. may be capable of performing subtractive construction based on an image, but may be limited to two levels (e.g., etched and not etched, cut or not cut, etc.) or an otherwise reduced number of discretization levels compared to an original number of discretization levels of the image. Example aspects of the present disclosure can especially find benefit in these and other scenarios in which a limited display medium is intended to display a full-color image, and in which it is desirable to maintain visual integrity (e.g., comprehensibility) of the image. One of ordinary skill in the art should understand that the systems and methods described herein are discussed with respect to image data for the purpose of illustration, and may be extended to any suitable tensor data having a plurality of discretization levels and/or one or more channels.

Some existing approaches for image binarization can fail to maintain, in the binarized images, visual information available in original images. For instance, one example approach to image binarization is thresholding, where each pixel of an image is converted to one of two colors (e.g., black and white) based on an intensity at the pixel, which is typically a cross-channel intensity, such as an averaged intensity of each color. While this approach can produce binarized images, it can lose detail compared to the original image. For example, thresholding can fail to replicate distinctions between differently colored regions in the binarized images, instead producing an uninterpretable region of shading for many images, and especially images having many different colors with similar intensities. Another example approach is dithering. Dithering, like thresholding, frequently fails to capture distinctions between colors, and additionally adds darkening or other noise to the output images. Furthermore, dithering often loses detail. Another example approach is edge representation. Edge representations can frequently worsen noise (e.g., JPEG compression noise) and may fail to represent colors, instead merely defining edges between colors. Furthermore, edge representations can become incomprehensible for detailed images. As such, many if not all existing approaches to image binarization fail to maintain visual integrity of the original image, and can often fail to adequately resemble the original image. Furthermore, these images may appear unpleasant to a viewer in addition to failing to convey information available in the original image.

Another challenge in image binarization relates to a lack of availability of suitable training data for machine learning. For instance, conventional generative machine-learning techniques require existing example output data, such sets of input and output data, that represent desired performance by a machine-learned model. Sufficient volumes of adequately binarized or level-reduced output data can be difficult or impossible to create manually. Furthermore, creating binarized output data for training by an existing method produces output data that includes the aforementioned problems with existing methods. Use of this training data may not allow a machine-learned model to provide any improvements over existing methods. Thus, challenges are encountered in the use of machine learning to binarize images.

Systems and methods according to example aspects of the present disclosure can provide solutions for these and other problems. For instance, systems and methods according to example aspects of the present disclosure can provide level-reduced tensor data having improved representation of visual information. For example, if the level-reduced tensor data is image data, the reduced discretization level image data can better capture information available in the original image, such as channel (e.g., color) boundaries, shapes and regions, subject of the image, etc. compared to level-reduced images produced by existing methods, such as thresholding, dithering, edge representation, etc.

As used herein, a discretization level refers to one of a discrete plurality of values that may be held by a value of the tensor within a particular channel. For example, an image having 256 discretization levels for each channel may include pixel values having intensities between 0 and 255 for each channel and at each pixel. Generally, a number of discretization levels can correspond to a number of bits used to store each item of the tensor data and/or an output capability of a medium that interprets the tensor data. For example, a data item in the tensor data having 256 discretization levels may require 8 bits to store and/or may be used to drive a pixel color in a display screen to one of 256 discrete intensities. As another example, a data item in tensor data having two discretization levels may be used to turn a pixel on or off, print or not print a point, etc. While a greater number of channels and/or discretization levels may convey more information, this can additionally contribute to an increased memory requirement for storage and/or increased cost and/or computational requirement(s) to display.

According to example aspects of the present disclosure, level-reduced tensor data can be produced from input tensor data by a machine-learned discretization level reduction model. The machine-learned discretization level reduction model can be configured to receive input tensor data including at least one channel and produce, in response to receiving the input tensor data, level-reduced tensor data. The level-reduced tensor data can include a reduced number of discretization levels (e.g., in comparison to the input tensor data). The level-reduced tensor data can approximate (e.g., visually approximate) the input tensor data. For example, the reduced discretization level image may be a bitonal image having two discretization levels. The bitonal image can approximate a full-color image having a greater plurality of discretization levels, such as 256 discretization levels. Additionally and/or alternatively, in some implementations, the level-reduced tensor data can include fewer channels than the input tensor data. For example, the level-reduced tensor data may include a single channel while the input tensor data may include greater than one channel (e.g., three channels, four channels, etc.).

In some implementations, the machine-learned discretization level reduction model can include a plurality of layers. For instance, the layers can form a network that transforms the input tensor data to the output tensor data. Furthermore, in some implementations, the layers can reconstruct input tensor data from the output tensor data. The reconstructed input data can be an attempt to recreate the input tensor data using the level-reduced tensor data and, in some implementations, information from a color bypass network. For instance, the reconstructed input tensor data can be used to determine a loss with respect to the original input tensor data. The loss can be backpropagated through each of the layers to train the model. In some implementations, the reconstructed input data can be produced using only the level-reduced tensor data and/or color bypass network information, which can intuitively provide that the model is trained to include information required to reconstruct the input tensor data in the level-reduced tensor data. The reconstructed input tensor data can be used for training the model.

The discretization level reduction model can include at least one input layer configured to receive the tensor data. For instance, the input layer can receive tensor data such as pixel data (e.g., an M×N image). The input layer can serve as an entry point for the tensor data.

In some implementations, the discretization level reduction model can include at least one feature representation layer. For instance, in some implementations, the at least one feature representation layer can be or can include a convolutional layer, such as a 3×3, 6×6, etc. convolutional layer. The feature representation layer(s) can map (e.g., by convolution) the input tensor data from the input layer to a feature representation of the input tensor data, such as a feature map. In some implementations, the feature representation layer(s) can be stride-1 convolutional layer(s), such as 3×3, stride-1 convolutional layer(s).

For example, a convolutional layer can operate by applying a convolutional kernel, such as a weighted kernel, to data in a prior layer. The kernel may be applied at a center, such as a corresponding position in the prior layer. A stride of the layer can refer to a number of positions for which the kernel is shifted for each value in the convolutional layer. A value can be computed by application of the convolutional kernel. The value can be provided as input to an activation function, and the output of the activation function can be a value at the convolutional layer (e.g., at a unit of the convolutional layer). The use of convolutional layers in the discretization level reduction model (e.g., at the level reduction layer(s)). can be beneficial according to example aspects of the present disclosure. For instance, convolutional layers can intuitively prevent the binarized representations (e.g., level-reduced tensor data) from becoming uninterpretable, as the representations can be formed of only data specified by the kernel of the convolutional layer.

While convolutional layers are provided as one example implementation, it will be appreciated that other implementations may alternatively be used. By way of example only, self-attention-based models, such as Transformers, may be used, alone or in combination with convolutional layers, to provide the feature representation layer.

In some implementations, the machine-learned discretization level reduction model can be or can include a channel reduction layer. For example, the channel reduction layer can be configured to receive input data from a prior layer (e.g., the input layer(s) and/or feature representation layer(s)). The input data from the prior layer may have a first number of channels, such as, for example, three channels, four channels, etc. The channel reduction layer can reduce the input data having a first number of channels to output data having a second (e.g., reduced) number of channels, such as, for example, a single channel. For instance, the channel reduction layer can combine data from a plurality of channels into a reduced plurality of channels and/or a single channel. As an example, the channel reduction layer can intuitively transform data indicative of a full-color image to data indicative of a grayscale image corresponding to the full color image. In some implementations, the channel reduction layer may preserve a number of discretization levels. For example, the input data and/or output data of the channel reduction layer may have a same number of discretization levels.

According to example aspects of the present disclosure, the machine-learned discretization level reduction model can include one or more level reduction layers connecting the at least one input layer to the output layer. For instance, the level reduction layer(s) can receive input data from prior layer(s) (e.g., the input layer(s), feature reduction layer(s), channel reduction layer(s), prior level reduction layer(s), etc.). In some implementations, the level reduction layer(s) can be or can include convolutional layer(s), such as a 3×3, 6×6, etc. convolutional layer(s). In some implementations, the level reduction layer(s) can be stride-1 convolutional layer(s).

The one or more level reduction layers can each be configured to reduce the number of discretization levels based at least in part on a scaling factor. In some implementations, the scaling factor may be one half. For instance, in some implementations, each of the level reduction layer(s) can reduce a discretization level at the output of the layer to half of the discretization level at the input of the layer. For example, if the input to the layer has a channel with 128 discretization levels, the output may have 64 discretization levels for the channel. Other suitable scaling factors to reduce the discretization level may be employed in accordance with example aspects of the present disclosure. In some implementations, each level reduction layer may have a same scaling factor (e.g., one half). Additionally and/or alternatively, in some implementations, a first level reduction layer can have a first scaling factor and a second level reduction layer can have a second scaling factor that is different from the first scaling factor.

As one example, the discretization level can be reduced at each level reduction layer by a discretized activation function having a plurality of activation levels corresponding to the desired amount of discretization levels at the layer. For instance, in some implementations, the level reduction layer(s) can each include a discretized activation function having a plurality of activation levels that corresponds to a reduced number of discretization levels from a prior layer. In some implementations, each level reduction layer can have a discretized activation function having a number of activation levels that is half that of a prior layer (e.g., an immediately prior layer). In some implementations, the discretized activation function can be a discretized tanh function. For example, the discretized tanh function can be discretized to a discrete plurality of outputs for any given input.

In some implementations, the activation functions in at least the level reduction layer(s) can be ignored during training (e.g., backpropagation) of the discretization level reduction model. For instance, the activation functions may be utilized during forward propagation and/or inference, but may be unaffected during a backpropagation step. For example, the activation functions may not be modified during training.

According to example aspects of the present disclosure, a discretization level reduction model can include any suitable number of level reduction layer(s). For instance, the number of level reduction layer(s) can be based at least in part on a desired number of discretization levels at the output layer and/or a scaling factor by which each level reduction layer reduces the number of discretization levels. For example, one example implementation includes seven level reduction layers that each reduce a number of discretization levels at the output to half that at the input. For example, the example implementation can be configured to reduce input data having 256 discretization levels to binarized output data having two discretization levels. As another example, if the output data is desired to have four discretization levels, only five level reduction layers, each reducing a number of discretization levels to half of the input levels, can be included. For instance, in some implementations, the level reduction layer(s) can progressively and/or monotonically reduce a number of discretization levels at each of the one or more level reduction layers. For instance, each subsequent level reduction layer can have fewer discretization levels than a prior level reduction layer.

According to example aspects of the present disclosure, a discretization level reduction model can include an output layer configured to provide the level-reduced tensor data. For example, the output layer can provide the level-reduced tensor data as an output of the discretization level reduction model (e.g., an image). In some implementations, the output layer can additionally be a final level reduction layer. For example, the output layer can reduce input from a next-to-final level reduction layer to output data having a desired number of discretization levels in addition to providing the output data as output of the discretization level reduction model. As another example, the output layer can be a final level reduction layer configured to reduce a number of discretization levels of an input to the output layer to the reduced number of discretization levels of the level-reduced tensor data. In some implementations, the reduced number of discretization levels of the level-reduced tensor data can be two discretization levels (e.g., 0 and 1). In some implementations, the output layer includes a spatial component (e.g., an image of M×N binary pixels), such the representation found in the output layer can be returned directly as an image, such as without any further transformations or other modifications. In some implementations, the intermediate level reduction layer(s) may be omitted such that the model goes directly from an input resolution to the desired output resolution. ignored

Additionally and/or alternatively, the machine-learned discretization level reduction model can include one or more reconstruction layers. The reconstruction layer(s) can be subsequent to the output layer. For instance, the reconstruction layer(s) can attempt to reconstruct the input tensor data from the level-reduced tensor data. In some implementations, the reconstruction layer(s) can be structurally similar to and/or identical to the feature representation layer(s). For instance, in some implementations, the reconstruction layer(s) can be or can include convolutional layer(s), such as 3×3, 6×6, etc. convolutional layer(s) and/or stride-1 convolutional layer(s). The reconstruction layer(s) can be used during at least training and/or may be unused during inference. For instance, the reconstruction layer(s) may be omitted from deployed models and/or included at deployed models, such as for tuning the model after deployment. For example, the reconstructed input data may not be used or provided as output of the model.

Intuitively, including reconstruction layers for at least training can ensure that the model learns to produce output tensor data that includes enough channel (e.g., color) and/or spatial information to accurately reconstruct the original tensor data (e.g., image). For instance, this can result in enough color information being included in the binary image (e.g., as learned binary patterns) that the color information can be perceived within the binary image itself. Thus, while the reconstruction layers may not be used in generating the final output of the machine-learned discretization level reduction model, they can provide improved generative capability of the model when employed during a training step. This can be beneficial in cases where supervised training data is not readily available (e.g., suitable binarized images), as the model can be trained in an unsupervised manner on only readily available input data (e.g., any suitable image).

In some implementations, dimensions of the tensor data can be preserved by the machine-learned discretization level reduction model. For example, some or all dimensions (e.g., length, width, height, etc.) of the input tensor data can be identical to corresponding dimensions of the level-reduced tensor data. For example, a binarized image produced by the machine-learned discretization level reduction model may be the same visual size (e.g., width×height) as an input image.

In some implementations, the discretization level reduction model can further include a color bypass network. The color bypass network can pass image-wide information (e.g., color information) past some or all layers of the discretization level reduction model. For instance, the color bypass network can pass image-wide information such as hue and/or color information to provide for reconstruction of a color bypass reconstruction that is separate from the reconstruction generated by the reconstruction layer(s). The color bypass network can include one or more hidden units. In some implementations, the color bypass network can be fully connected to a layer of the discretization level reduction model, such as, for example, the input layer. For example, the color bypass network can include one or more fully connected hidden units that are fully connected to the layer. For instance, including fully connected hidden units can allow the hidden units to capture image-wide information. In implementations where the layers of the discretization level reduction model are convolutional layers, this can provide that the layers (e.g., feature representation layer(s), level reduction layer(s), etc.) can capture localized spatial information while the color bypass network can capture image-wide information, such as tint, hue, etc.

Intuitively, including a color bypass network allows for image-wide information such as tint, hue, etc. to be passed to a color bypass reconstruction. This provides that it is not necessary to capture this information, which may not be useful in a level-reduced representation (e.g., as the level-reduced representation may lack, for example, color channels), at the level-reduced tensor data. Rather, this information is passed through a supplementary color bypass network, providing for the level-reduced tensor data to include (e.g., by virtue of convolutional layers, in some implementations) increased localized spatial/boundary information, which can be useful for providing level-reduced tensor data with improved visual information. However, by passing this information through the color bypass network, it can be utilized for training the model. For example, the reconstruction from the reconstruction layers, as a first reconstructed input tensor data component, can be combined with the color bypass reconstruction, as a second reconstructed input tensor data component, to reconstruct the reconstructed input tensor data. The model can then be trained on this reconstructed input tensor data (e.g., as opposed to the reconstruction from the reconstruction layers directly).

Generally, it is desirable that the color bypass network includes enough hidden units to capture desirable image-wide information, but not so large that the color bypass network will capture localized information, which can prevent that information from being included at the level-reduced tensor data. Thus, in some implementations, the color bypass network can include between one and ten hidden units, such as one and ten fully connected hidden units. For instance, in some implementations, the color bypass network can include two hidden units. Intuitively, these two hidden units can capture information related to a dimension of the image, such as a width-directed color gradient and/or a height-directed color gradient, although this is described for the purposes of illustration only, and the hidden units may capture any suitable image-wide information.

In some implementations, a computing system can be configured for providing level-reduced tensor data having improved representation of visual information. The computing system can include (e.g., store in memory) a machine-learned discretization level reduction model according to example aspects of the present disclosure. For instance, the discretization level reduction model can be configured to receive tensor data including at least one channel and produce, in response to receiving the tensor data, level-reduced tensor data including a reduced number of discretization levels for the at least one channel.

The computing system can include one or more processors and one or more computer-readable memory devices storing instructions that, when implemented, cause the one or more processors to perform operations. For example, the operations can implement a computer-implemented method for providing level-reduced tensor data having improved representation of visual information. As one example, the operations can include obtaining the tensor data. Additionally and/or alternatively, the operations can include providing the tensor data as input to the machine-learned discretization level reduction model. Additionally and/or alternatively, the operations can include obtaining, from the machine-learned discretization level reduction model, the level-reduced tensor data.

In some implementations, the machine-learned discretization level reduction model can be stored in computer-readable memory. For example, one or more non-transitory, computer-readable media can store a machine-learned discretization level reduction model according to example aspects of the present disclosure. For instance, the discretization level reduction model can be configured to receive tensor data including at least one channel and produce, in response to receiving the tensor data, level-reduced tensor data including a reduced number of discretization levels for the at least one channel.

In some implementations, a computing system can be configured to implement a computer-implemented method for training a discretization level reduction model to provide level-reduced tensor data having improved representation of visual information. For example, the computing system can include one or more computing devices. As one example, the computing system can be a training computing system that is configured to train and/or distribute the discretization level reduction model. As another example, the computing system can be a local computing system, such as a client computing system and/or a server computing system, that is configured to train and/or perform inference using the discretization level reduction model.

The computer-implemented method can include obtaining (e.g., by a computing system including one or more computing devices) training data. The training data can be any suitable training data used to train the discretization level reduction model. For instance, the training data can include input tensor data. In many cases, it can be difficult or impossible to prepare supervised training data (e.g., pairs of input and desired output data) and, as such, the systems and methods described herein can provide for unsupervised training. For example, the training data may include only input data, such as a corpus of images.

The computer-implemented method can include providing (e.g., by the computing system) the training data to a discretization level reduction model. The discretization level reduction model can be configured to receive tensor data having a number of discretization levels and produce, in response to receiving the tensor data, level-reduced tensor data having a reduced number of discretization levels.

The discretization level reduction model can be any suitable discretization level reduction model according to example aspects of the present disclosure. For instance, in some implementations, the discretization level reduction model can include at least one input layer configured to receive the input tensor data. Additionally and/or alternatively, in some implementations, the discretization level reduction model can include an output layer configured to provide the level-reduced tensor data. Additionally and/or alternatively, in some implementations, the discretization level reduction model can include one or more level reduction layers connecting the at least one input layer to the output layer. The one or more level reduction layers can be configured to reduce a number of discretization levels at each of the one or more level reduction layers. For instance, in some implementations, the level reduction layer(s) can progressively and/or monotonically reduce a number of discretization levels at each of the one or more level reduction layers. For instance, each subsequent level reduction layer can have fewer discretization levels than a prior level reduction layer.

Additionally and/or alternatively, in some implementations, the discretization level reduction model can include one or more reconstruction layers configured to reconstruct the reconstructed input tensor data from the level-reduced tensor data. Furthermore, in some implementations, the discretization level reduction model can include a color bypass network, such as a color bypass network including one or more fully connected hidden units, such as from one to ten hidden units, such as two hidden units.

The computer-implemented method can include determining (e.g., by the computing system), based at least in part on the discretization level reduction model, the level-reduced tensor data. For instance, the level-reduced tensor data can be determined by the discretization level reduction model, such as by an output layer of the discretization level reduction model. The level-reduced tensor data may be provided as output and/or may be propagated for training the model (e.g., with or without being provided as output). In some implementations, the level-reduced tensor data can be or can include a binarized image generated from an input image of the training data. For example, in some implementations, the input tensor data can be or can include image data and/or the level-reduced tensor data can be or can include binarized image data. As one example, the level-reduced tensor data can be determined by providing the input tensor data to a discretization level reduction model including, for example, input layer(s), feature representation layer(s), channel reduction layer(s), level reduction layer(s), and/or output layer(s).

The computer-implemented method can include determining (e.g., by the computing system), based at least in part on the discretization level reduction model, reconstructed input tensor data based at least in part on the level-reduced tensor data. For instance, the reconstructed input tensor data can be reconstructed from at least the level-reduced tensor data, such as by reconstruction layer(s) of the discretization level reduction model. The reconstructed input tensor data can resemble the input tensor data. For instance, the reconstructed input tensor data can include a greater amount of information and/or information in a more easily perceived manner than the level-reduced tensor data, including information that is extrapolated from the level-reduced tensor data to recreate the input tensor data. Generally, it is desirable for the reconstructed input tensor data to be as close to the input tensor data as possible while conforming to the structure of the discretization level reduction model. In this way, the model can learn to provide sufficient spatial information at the level-reduced tensor data to closely reconstruct the input tensor data.

In some implementations, such as implementations where the discretization level reduction model includes a color bypass network, determining the reconstructed input tensor data can be based at least in part on the level-reduced tensor data and a color bypass reconstruction. For instance, in some implementations, determining the reconstructed input tensor data can include obtaining (e.g., by the computing system) a first reconstructed input tensor data component. The first reconstructed input tensor data component can be obtained from the one or more reconstruction layers. The first reconstructed input tensor data component can be based at least in part on the level-reduced tensor data. For example, the first reconstructed input tensor data component can be (e.g., intermediate) reconstructed input tensor data that is produced by the reconstruction layers from the level-reduced tensor data. As one example, the first reconstructed input tensor data component can be a reconstructed image (e.g., a full-color image) that approximates an input image. For example, the reconstructed image can have a same number of channels and/or discretization levels as the input image. According to example aspects of the present disclosure, this image can be made to more closely approximate the input image by including information from the color bypass network.

Additionally and/or alternatively, in some implementations, determining the reconstructed input tensor data can include obtaining (e.g., by the computing system) a second reconstructed input tensor data component. The second reconstructed input tensor data component can be obtained from the color bypass network. For instance, in some implementations, the second reconstructed input tensor data can be a color bypass reconstruction. For example, the second reconstructed input tensor data component can be obtained from a color bypass reconstruction layer that is included in and/or otherwise connected to the color bypass network. The second reconstructed input tensor data component can be based at least in part on the input tensor data. For example, in some implementations, the second reconstructed input tensor data component can be obtained based at least in part on a color bypass network that is connected to (e.g., fully connected to, such as by including at least one fully connected hidden unit), an input layer including the input tensor data. In some implementations, the second reconstructed input tensor data component may be a reconstructed image based on an input image. The second reconstructed input tensor component may be a reconstructed image that includes less localized spatial information than a reconstructed image of the first reconstructed input tensor data component. For example, the second reconstructed input tensor data component can be a color tint for the reconstructed image, such as one or more gradients, etc.

Additionally and/or alternatively, in some implementations, determining the reconstructed input tensor data can include determining (e.g., by the computing system) the reconstructed input tensor data based at least in part on the first reconstructed input tensor data component and the second reconstructed input data component. For instance, in some implementations, the reconstructed input tensor data can be determined based at least in part on a pixel-wise combination of the first reconstructed input tensor data component and the second reconstructed input data component.

The computer-implemented method can include determining (e.g., by the computing system) a loss based at least in part on the input tensor data and the reconstructed input tensor data. For instance, in some implementations, the loss can be or can include a pixel-wise difference between the input tensor data and the reconstructed input tensor data. For example, the loss can convey a difference between the input tensor data and the reconstructed input data. The loss may include or otherwise define one or more gradients, such as gradients with respect to parameters of the discretization level reduction model. For instance, in some implementations, the model may be trained with a backpropagation/optimization algorithm such as Adam.

The computer-implemented method can include adjusting (e.g., by the computing system) one or more parameters of the discretization level reduction model based at least in part on the loss. The discretization level reduction model can include one or more parameters such as, for example, node and/or link weights, kernel weights, activation values or levels, etc. of the layer(s), such as the input layer(s), feature representation layer(s), channel reduction layer(s), level reduction layer(s), output layer(s), reconstruction layer(s), etc., and/or the color bypass network, and/or other portions of the discretization level reduction model. These parameters can be adjusted based on the loss, such as based on a gradient of the loss. For example, the loss (e.g., gradient of the loss) can be backpropagated through the discretization level reduction model to adjust parameters of the model and thereby train the model. In some implementations, the activation values or levels of a discretized activation function, such as a discretized tanh activation function, may be unchanged during training. For instance, as the discretized activation function is defined to discretize inputs, it may be unnecessary to shift, scale, or otherwise modify the activation function during training. Thus, the activation levels of the discretized activation function may be ignored during a backpropagation step, which can contribute to ease of training the model.

In at least this manner, the discretization level reduction model can be trained to produce level-reduced tensor data that includes enough information to reconstruct sufficiently accurate reconstructed input tensor data. This can provide for level-reduced tensor data that includes sufficient amounts of spatial information, which can translate into improved viewability and/or usability of, for example, images of the level-reduced tensor data, among various other uses. Furthermore, the systems and methods described herein can provide for training a discretization level reduction model even in cases where sufficient volumes of supervised training data are difficult and/or impossible to produce. For example, the model can be trained (e.g., only) using readily-available images while requiring few to no modifications on the images.

Intuitively, the machine-learned discretization level reduction model can learn to map colors of a full-color image into different binary or other level-reduced hashes or textures. The model can also intuitively learn “texture mappings” that visually reflect their source colors by virtue of being similar in cases of similar colors. This behavior is not explicitly defined, and is in fact an unexpected result of configuring a machine-learned model in such a manner as described according to example aspects of the present disclosure. This behavior can provide for generation of level-reduced images that can better capture visual information and thus improve usability of the images.

Systems and methods according to example aspects of the present disclosure can find application in a variety of applications. As one example, systems and methods described herein can be employed for bitonal printing. For instance, bitonal printing can be faster and/or performed with reduced cost compared to, for example, grayscale and/or color printing. Bitonal printing may be suitable for, for example, bulk printing of worksheets, newspapers, or other suitable media. For example, according to example aspects of the present disclosure, systems and methods described herein can be used to convert a grayscale and/or full-color image to a bitonal image suitable for bitonal printing. As one example, the systems and methods described herein may be incorporated into driver software or other software associated with printer hardware. As another example, the systems and methods described herein may be used to prepare a document for printing.

As another example, systems and methods described herein can be employed as a web service or other image processing service. For example, a user may upload a (e.g., full-color) image to the image processing service and receive, as output from the service, a binarized or other bit-reduced image. The service may be a local service, such as a service that is stored on memory of a computing device that the user operates, and/or a web service, such as a service that is stored remote from the computing device that the user operates and/or is accessed via the Internet or other network. As one example, the systems and methods described herein may be incorporated into an image filter that converts a full-color image into a bitonal or other bit-reduced image.

As another example, systems and methods described herein can be used to generate images and/or schematics for some construction applications, such as subtractive construction (e.g., laser etching, CNC machines, machine cutters, etc.). For example, systems and methods described herein can be incorporated into driver software or other software associated with a subtractive construction system. As another example, systems and methods described herein can be used to generate images or other (e.g., binary) schematics that are provided to subtractive construction system(s).

As another example, systems and methods described herein can be used to generate bitonal or other bit-reduced images for display on a bitonal or other limited display. For example, systems and methods described herein can be used to generate images for bitonal displays (e.g., bitonal pixel displays), such as e-readers, electronic ink displays, calculators, etc. As one example, systems and methods described herein can be included as software on devices including a bitonal display.

As another example, systems and methods described herein can be used as a lossy compression scheme. For example, the discretization level reduction model can be used to produce level-reduced tensor data from input tensor data. The reduced discretization tensor data can require fewer computational resources (e.g., fewer bits in memory, less bandwidth, etc.) to store and/or transfer and/or interpret than the input tensor data. The reconstruction layer(s) can then be used to reconstruct the input tensor data, such as at a later point in time and/or at a computing system other than that at which the level-reduced tensor data was generated.

Systems and methods described herein can provide for a number of technical effects and benefits, including, but not limited to, improvements to computing technology. As one example, systems and methods described herein can produce level-reduced tensor data having improved retention of spatial information from input tensor data. This improved retention of spatial information can contribute to improved usability of the tensor data, such as, for example, improved viewability and/or information transmission capabilities for binarized or other level-reduced images. This can provide for level-reduced tensor data that is more reflective of input tensor data, which can improve usability as a lossy compression scheme, display on limited-capability displays, etc.

As another example, the improved retention of spatial information can provide for level-reduced tensor data having improved retention of spatial information to be used in applications for which it has been necessary to use higher-level tensor data due to an inability of level-reduced tensor data according to conventional methods to convey enough information to be useful in those applications. For example, an application that previously required full-color images due to an inability of conventional binarized images to convey adequate spatial information may find use of binarized images produced according to example aspects of the present disclosure that may convey adequate spatial information. This can provide for computing resource savings in at least these applications, as the binarized images and/or other level-reduced tensor data produced according to example aspects of the present disclosure can have reduced computing resource requirements (e.g., fewer bits per pixel) for storage, transmission, and/or interpretation.

With reference now to the Figures, example implementations of the present disclosure will be discussed in further detail.

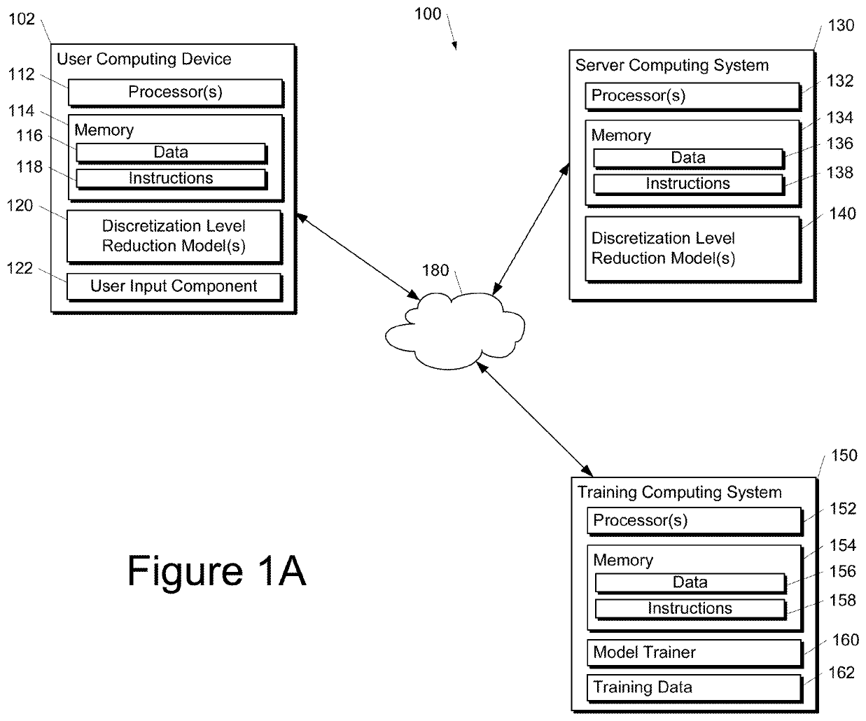

FIG. 1A depicts a block diagram of an example computing system 100 that performs discretization level reduction according to example implementations of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

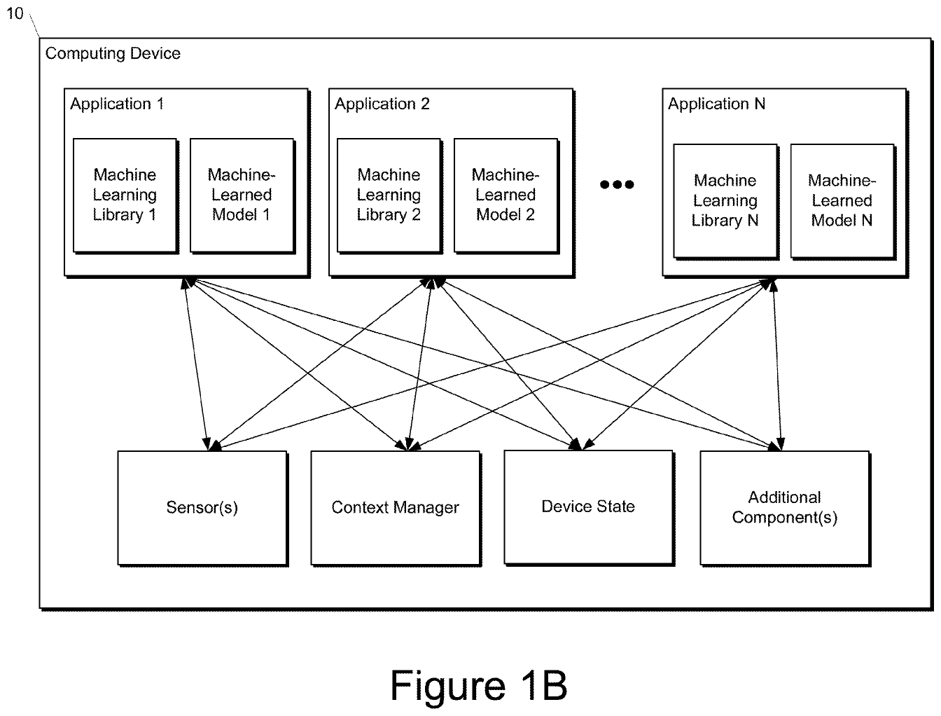

In some implementations, the user computing device 102 can store or include one or more discretization level reduction models 120. For example, the discretization level reduction models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example discretization level reduction models 120 are discussed with reference to FIGS. 2 through 5.

In some implementations, the one or more discretization level reduction models 120 can be received from the server computing system 130 over network 180, stored in the user computing device memory 114, and then used or otherwise implemented by the one or more processors 112. In some implementations, the user computing device 102 can implement multiple parallel instances of a single discretization level reduction model 120 (e.g., to perform parallel discretization level reduction across multiple instances of discretization level reduction models).

More particularly, according to example aspects of the present disclosure, level-reduced tensor data can be produced from input tensor data by a machine-learned discretization level reduction model 120. The machine-learned discretization level reduction model 120 can be configured to receive input tensor data including at least one channel and produce, in response to receiving the input tensor data, level-reduced tensor data. The level-reduced tensor data can include a reduced number of discretization levels (e.g., in comparison to the input tensor data). The level-reduced tensor data can approximate (e.g., visually approximate) the input tensor data. For example, the reduced discretization level image may be a bitonal image having two discretization levels. The bitonal image can approximate a full-color image having a greater plurality of discretization levels, such as 256 discretization levels. Additionally and/or alternatively, in some implementations, the level-reduced tensor data can include fewer channels than the input tensor data. For example, the level-reduced tensor data may include a single channel while the input tensor data may include greater than one channel (e.g., three channels, four channels, etc.).

Additionally or alternatively, one or more discretization level reduction models 140 can be included in or otherwise stored and implemented by the server computing system 130 that communicates with the user computing device 102 according to a client-server relationship. For example, the discretization level reduction models 140 can be implemented by the server computing system 140 as a portion of a web service (e.g., a discretization level reduction service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned discretization level reduction models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2 through 5.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. In some implementations, for example, the model(s) 120 and/or 140 may be stored at model trainer 160 during training and subsequently transmitted to the user computing device 120 and/or the server computing system 130. The model trainer 160 may provide layer(s) and/or other components of the discretization model used for inference (e.g., the input layer, output layer, and layer(s) connected therebetween) and may provide and/or retain layer(s) and/or other components of the model used for training (e.g., the reconstruction layer(s), reconstruction output layer(s), color bypass network, etc.).

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the discretization level reduction models 120 and/or 140 based on a set of training data 162. The training data 162 can include, for example, any suitable training data 162 used to train the discretization level reduction model(s) 120, 140. For instance, the training data 162 can include input tensor data, such as image data (e.g., full color image data). The image data may be provided in any suitable (e.g., digital) image format, such as, for example, BMP, JPEG/JPG, PNG, TIFF, or any other suitable format. In many cases, it can be difficult or impossible to prepare supervised training data (e.g., pairs of input and desired output data) and, as such, the systems and methods described herein can provide for unsupervised training. For example, the training data 162 may include only input data, such as a corpus of images.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs discretization level reduction according to example implementations of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs discretization level reduction according to example implementations of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

FIG. 2 depicts a block diagram of an example discretization level reduction system 200 according to example implementations of the present disclosure. The discretization level reduction system 200 can include a machine-learned discretization level reduction model 202. In some implementations, the discretization level reduction model 202 is trained to receive a set of input data 204 descriptive of input tensor data and, as a result of receipt of the input data 204, provide output data 206 that is descriptive of level-reduced tensor data.

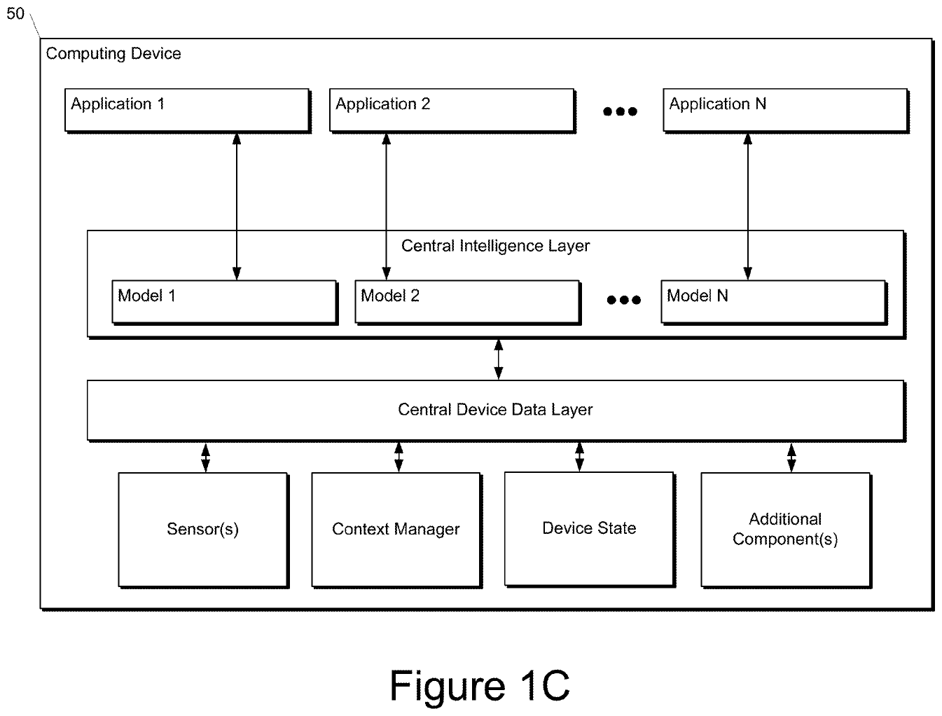

FIG. 3 depicts a block diagram of an example discretization level reduction model 300 according to example implementations of the present disclosure. The discretization level reduction model 300 includes discretization level reduction layer(s) 302. The discretization level reduction layer(s) can include layers that are configured to reduce input data 204 (e.g., input tensor data) to output data 206 (e.g., level-reduced tensor data). For instance, the discretization level reduction layer(s) 302 can be layers that produce an overall output of the discretization level reduction model 300. As examples, the discretization level reduction layer(s) 302 can be or can include input layer(s), feature representation layer(s), channel reduction layer(s), level reduction layer(s), and/or output layer(s).

Additionally and/or alternatively, the discretization level reduction model 300 can include reconstruction layer(s) 304. The reconstruction layer(s) 304 can produce reconstructed input data 306 (e.g., reconstructed input tensor data) from at least output data 206 (e.g., level-reduced tensor data). For instance, the reconstruction layer(s) 304 can include a reconstruction output layer that provides the reconstructed input data 306. The reconstructed input data 306 may or may not be provided as an output of the discretization level reduction model 300. Generally, the reconstructed input data 306 is used to train the model 300 to improve predictions at the output data 206, as described herein.

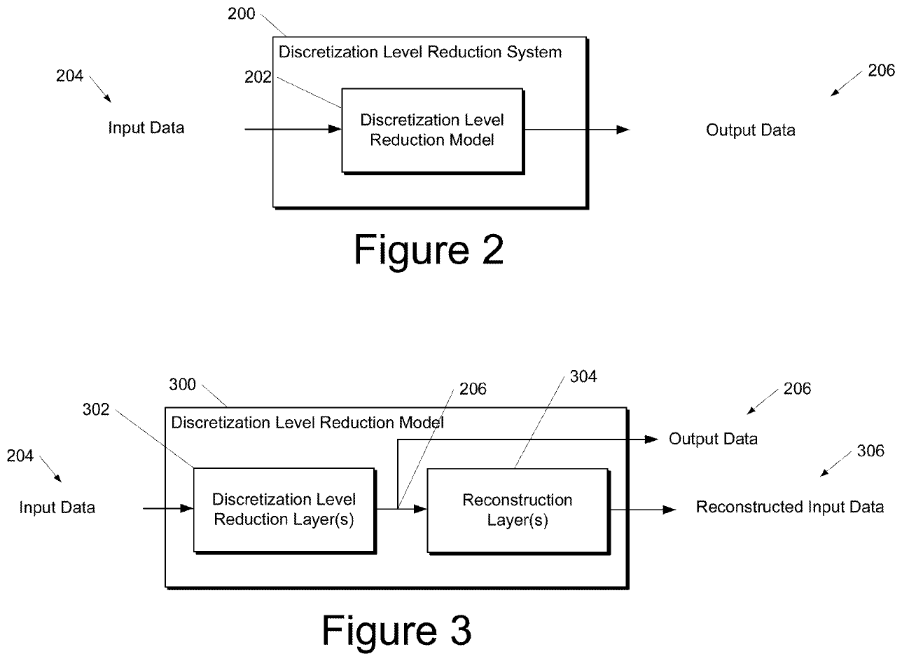

FIG. 4 depicts a block diagram of an example discretization level reduction model 400 according to example implementations of the present disclosure. According to example aspects of the present disclosure, output data 206 (e.g., level-reduced tensor data) can be produced from input data 204 (e.g., input tensor data) by discretization level reduction model 400. The machine-learned discretization level reduction model 400 can be configured to receive input tensor data including at least one channel and produce, in response to receiving the input tensor data, level-reduced tensor data. The level-reduced tensor data can include a reduced number of discretization levels (e.g., in comparison to the input tensor data). The level-reduced tensor data can approximate (e.g., visually approximate) the input tensor data. For example, the reduced discretization level image may be a bitonal image having two discretization levels. The bitonal image can approximate a full-color image having a greater plurality of discretization levels, such as 256 discretization levels. Additionally and/or alternatively, in some implementations, the level-reduced tensor data can include fewer channels than the input tensor data. For example, the level-reduced tensor data may include a single channel while the input tensor data may include greater than one channel (e.g., three channels, four channels, etc.).

In some implementations, the machine-learned discretization level reduction model 400 can include a plurality of layers. For instance, the layers can form a network that transforms the input data 204 (e.g., input tensor data) to the output data 206 (e.g., level-reduced tensor data). Furthermore, in some implementations, the layers can reconstruct the input data 204 (e.g., input tensor data) from the output data 206 (e.g., level-reduced tensor data). The reconstructed input tensor data can be used for training the model 400. For instance, the reconstructed input tensor data can be used to determine a loss with respect to the original input tensor data. The loss can be backpropagated through each of the layers to train the model 400.

The discretization level reduction model 400 can include at least one input layer 402 configured to receive the tensor data. For instance, the input layer 402 can receive tensor data such as pixel data (e.g., an M×N image). The input layer 402 can serve as an entry point for the tensor data.

In some implementations, the discretization level reduction model 400 can include at least one feature representation layer 404. For instance, in some implementations, the at least one feature representation layer 404 can be or can include a convolutional layer, such as a 3×3, 6×6, etc. convolutional layer. The feature representation layer(s) 404 can map (e.g., by convolution) the input tensor data from the input layer 402 to a feature representation of the input tensor data, such as a feature map. In some implementations, the feature representation layer(s) 404 can be stride-1 convolutional layer(s), such as 3×3, stride-1 convolutional layer(s).

For example, a convolutional layer can operate by applying a convolutional kernel, such as a weighted kernel, to data in a prior layer. The kernel may be applied at a center, such as a corresponding position in the prior layer. A stride of the layer can refer to a number of positions for which the kernel is shifted for each value in the convolutional layer. A value can be computed by application of the convolutional kernel. The value can be provided as input to an activation function, and the output of the activation function can be a value at the convolutional layer (e.g., at a unit of the convolutional layer). The use of convolutional layers in the discretization level reduction model 400 (e.g., at the level reduction layer(s) 408) can be beneficial according to example aspects of the present disclosure. For instance, convolutional layers can intuitively prevent the binarized representations (e.g., level-reduced tensor data) from becoming uninterpretable, as the representations can be formed of only data specified by the kernel of the convolutional layer.

In some implementations, the machine-learned discretization level reduction model 400 can be or can include a channel reduction layer 406. For example, the channel reduction layer 406 can be configured to receive input data from a prior layer (e.g., the input layer(s) 402 and/or feature representation layer(s) 404). The input data from the prior layer may have a first number of channels, such as, for example, three channels, four channels, etc. The channel reduction layer 406 can reduce the input data having a first number of channels to output data having a second (e.g., reduced) number of channels, such as, for example, a single channel. For instance, the channel reduction layer 406 can combine data from a plurality of channels into a reduced plurality of channels and/or a single channel. As an example, the channel reduction layer 406 can intuitively transform data indicative of a full-color image to data indicative of a grayscale image corresponding to the full color image. In some implementations, the channel reduction layer 406 may preserve a number of discretization levels. For example, the input data and/or output data of the channel reduction layer 406 may have a same number of discretization levels.

According to example aspects of the present disclosure, the machine-learned discretization level reduction model 400 can include one or more level reduction layers 408 connecting the at least one input layer 402 to the output layer 410. For instance, the level reduction layer(s) 408 can receive input data from prior layer(s) (e.g., the input layer(s) 402, feature reduction layer(s), channel reduction layer(s) 406, prior level reduction layer(s) 408, etc.). In some implementations, the level reduction layer(s) 408 can be or can include convolutional layer(s), such as a 3×3, 6×6, etc. convolutional layer(s). In some implementations, the level reduction layer(s) 408 can be stride-1 convolutional layer(s).

The one or more level reduction layers 408 can each be configured to reduce the number of discretization levels based at least in part on a scaling factor. In some implementations, the scaling factor may be one half. For instance, in some implementations, each of the level reduction layer(s) 408 can reduce a discretization level at the output of the layer to half of the discretization level at the input of the layer. For example, if the input to the layer has a channel with 128 discretization levels, the output may have 64 discretization levels for the channel. Other suitable scaling factors to reduce the discretization level may be employed in accordance with example aspects of the present disclosure. In some implementations, each level reduction layer 408 may have a same scaling factor (e.g., one half). Additionally and/or alternatively, in some implementations, a first level reduction layer 408 can have a first scaling factor and a second level reduction layer 408 can have a second scaling factor that is different from the first scaling factor.

In some implementations, the level reduction layer(s) 408 can progressively and/or monotonically reduce a number of discretization levels at each of the one or more level reduction layers. For instance, each subsequent level reduction layer 408 can have fewer discretization levels than a prior level reduction layer 408. As one example, the discretization level can be reduced at each level reduction layer 408 by a discretized activation function having a plurality of activation levels corresponding to the desired amount of discretization levels at the layer. For instance, in some implementations, the level reduction layer(s) 408 can each include a discretized activation function having a plurality of activation levels that correspond to a reduced number of discretization levels from a prior layer. In some implementations, each level reduction layer 408 can have a discretized activation function having a number of activation levels that is half that of a prior layer (e.g., an immediately prior layer). In some implementations, the discretized activation function can be a discretized tanh function. For example, the discretized tanh function can be discretized to a discrete plurality of outputs for any given input.

In some implementations, the activation functions in at least the level reduction layer(s) 408 can be ignored during backpropagation of the discretization level reduction model 400. For instance, the activation functions may be utilized during forward propagation and/or inference, but may be unaffected during a backpropagation step. For example, the activation functions may not be modified during training.

According to example aspects of the present disclosure, discretization level reduction model 400 can include any suitable number of level reduction layer(s) 408. For instance, the number of level reduction layer(s) 408 can be based at least in part on a desired number of discretization levels at the output layer 410 and/or a scaling factor by which each level reduction layer 408 reduces the number of discretization levels. For example, one example implementation includes seven level reduction layers 408 that each reduce a number of discretization levels at the output to half that at the input. For example, the example implementation can be configured to reduce input data having 256 discretization levels to binarized output data having two discretization levels. As another example, if the output data is desired to have four discretization levels, only five level reduction layers 408, each reducing a number of discretization levels to half of the input levels, can be included.

According to example aspects of the present disclosure, discretization level reduction model 400 can include an output layer 410 configured to provide the level-reduced tensor data. For example, the output layer 410 can provide the level-reduced tensor data as an output of the discretization level reduction model 400 (e.g., an image). In some implementations, the output layer 410 can additionally be a final level reduction layer 408. For example, the output layer 410 can reduce input from a next-to-final level reduction layer 408 to output data having a desired number of discretization levels in addition to providing the output data as output of the discretization level reduction model 400. As another example, the output layer 410 can be a final level reduction layer 408 configured to reduce a number of discretization levels of an input to the output layer 410 to the reduced number of discretization levels of the level-reduced tensor data. In some implementations, the reduced number of discretization levels of the level-reduced tensor data can be two discretization levels (e.g., 0 and 1). In some implementations, the output layer 410 includes a spatial component (e.g., an image of M×N binary pixels), such the representation found in the output layer 410 can be returned directly as an image, such as without any further transformations or other modifications.

Additionally and/or alternatively, the machine-learned discretization level reduction model 400 can include one or more reconstruction layer(s) 412. The reconstruction layer(s) 412 can be subsequent to the output layer 410. For instance, the reconstruction layer(s) 412 can attempt to reconstruct the input tensor data from the level-reduced tensor data. As one example, a reconstruction output layer 414 (e.g., a final reconstruction layer) can provide the reconstructed input tensor data. In some implementations, the reconstruction layer(s) 412 can be structurally similar to and/or identical to the feature representation layer(s) 404. For instance, in some implementations, the reconstruction layer(s) 412 can be or can include convolutional layer(s), such as 3×3, 6×6, etc. convolutional layer(s) and/or stride-1 convolutional layer(s). The reconstruction layer(s) 412 can be used during at least training and/or may be unused during inference. For instance, the reconstruction layer(s) 412 may be omitted from deployed model 400s and/or included at deployed model 400s, such as for tuning the model 400 after deployment. For example, the reconstructed input data may not be used or provided as output of the model 400.

Intuitively, including reconstruction layer(s) 412 for at least training can ensure that the model 400 learns to produce output tensor data that includes enough channel (e.g., color) and/or spatial information to accurately reconstruct the original tensor data (e.g., image). For instance, this can result in enough color information being included in the binary image (e.g., as learned binary patterns) that the color information can be perceived within the binary image itself. Thus, while the reconstruction layer(s) 412 may not be used in generating the final output of the machine-learned discretization level reduction model 400, they can provide improved generative capability of the model 400 when employed during a training step. This can be beneficial in cases where supervised training data is not readily available (e.g., suitable binarized images), as the model 400 can be trained in an unsupervised manner on only readily available input data (e.g., any suitable image).

In some implementations, dimensions of the tensor data can be preserved by the machine-learned discretization level reduction model 400. For example, some or all dimensions (e.g., length, width, height, etc.) of the input tensor data can be identical to corresponding dimensions of the level-reduced tensor data. For example, a binarized image produced by the machine-learned discretization level reduction model 400 may be the same visual size (e.g., width×height) as an input image.

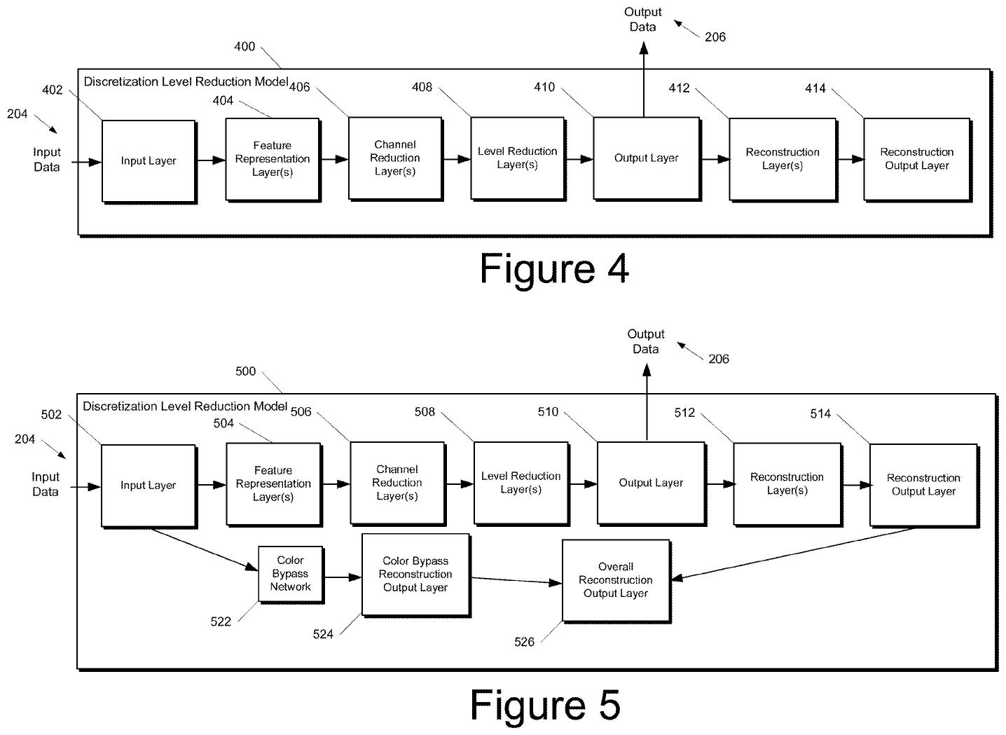

FIG. 5 depicts a block diagram of an example discretization level reduction model 500 according to example implementations of the present disclosure. According to example aspects of the present disclosure, output data 206 (e.g., level-reduced tensor data) can be produced from input data 204 (e.g., input tensor data) by discretization level reduction model 500. The machine-learned discretization level reduction model 500 can be configured to receive input tensor data including at least one channel and produce, in response to receiving the input tensor data, level-reduced tensor data. The level-reduced tensor data can include a reduced number of discretization levels (e.g., in comparison to the input tensor data). The level-reduced tensor data can approximate (e.g., visually approximate) the input tensor data. For example, the reduced discretization level image may be a bitonal image having two discretization levels. The bitonal image can approximate a full-color image having a greater plurality of discretization levels, such as 256 discretization levels. Additionally and/or alternatively, in some implementations, the level-reduced tensor data can include fewer channels than the input tensor data. For example, the level-reduced tensor data may include a single channel while the input tensor data may include greater than one channel (e.g., three channels, four channels, etc.).

In some implementations, the machine-learned discretization level reduction model 500 can include a plurality of layers. For instance, the layers can form a network that transforms the input data 204 (e.g., input tensor data) to the output data 206 (e.g., level-reduced tensor data). Furthermore, in some implementations, the layers can reconstruct the input data 204 (e.g., input tensor data) from the output data 206 (e.g., level-reduced tensor data). The reconstructed input tensor data can be used for training the model 500. For instance, the reconstructed input tensor data can be used to determine a loss with respect to the original input tensor data. The loss can be backpropagated through each of the layers to train the model 500.

The discretization level reduction model 500 can include at least one input layer 502 configured to receive the tensor data. For instance, the input layer 502 can receive tensor data such as pixel data (e.g., an M×N image). The input layer 502 can serve as an entry point for the tensor data.

In some implementations, the discretization level reduction model 500 can include at least one feature representation layer 504. For instance, in some implementations, the at least one feature representation layer 504 can be or can include a convolutional layer, such as a 3×3, 6×6, etc. convolutional layer. The feature representation layer(s) 504 can map (e.g., by convolution) the input tensor data from the input layer 502 to a feature representation of the input tensor data, such as a feature map. In some implementations, the feature representation layer(s) 504 can be stride-1 convolutional layer(s), such as 3×3, stride-1 convolutional layer(s).

For example, a convolutional layer can operate by applying a convolutional kernel, such as a weighted kernel, to data in a prior layer. The kernel may be applied at a center, such as a corresponding position in the prior layer. A stride of the layer can refer to a number of positions for which the kernel is shifted for each value in the convolutional layer. A value can be computed by application of the convolutional kernel. The value can be provided as input to an activation function, and the output of the activation function can be a value at the convolutional layer (e.g., at a unit of the convolutional layer). The use of convolutional layers in the discretization level reduction model 500 (e.g., at the level reduction layer(s) 508) can be beneficial according to example aspects of the present disclosure. For instance, convolutional layers can intuitively prevent the binarized representations (e.g., level-reduced tensor data) from becoming uninterpretable, as the representations can be formed of only data specified by the kernel of the convolutional layer.

In some implementations, the machine-learned discretization level reduction model 500 can be or can include a channel reduction layer 506. For example, the channel reduction layer 506 can be configured to receive input data from a prior layer (e.g., the input layer(s) 502 and/or feature representation layer(s) 504). The input data from the prior layer may have a first number of channels, such as, for example, three channels, four channels, etc. The channel reduction layer 506 can reduce the input data having a first number of channels to output data having a second (e.g., reduced) number of channels, such as, for example, a single channel. For instance, the channel reduction layer 506 can combine data from a plurality of channels into a reduced plurality of channels and/or a single channel. As an example, the channel reduction layer 506 can intuitively transform data indicative of a full-color image to data indicative of a grayscale image corresponding to the full color image. In some implementations, the channel reduction layer 506 may preserve a number of discretization levels. For example, the input data and/or output data of the channel reduction layer 506 may have a same number of discretization levels.

According to example aspects of the present disclosure, the machine-learned discretization level reduction model 500 can include one or more level reduction layers 508 connecting the at least one input layer 502 to the output layer 510. For instance, the level reduction layer(s) 508 can receive input data from prior layer(s) (e.g., the input layer(s) 502, feature reduction layer(s), channel reduction layer(s) 506, prior level reduction layer(s) 508, etc.). In some implementations, the level reduction layer(s) 508 can be or can include convolutional layer(s), such as a 3×3, 6×6, etc. convolutional layer(s). In some implementations, the level reduction layer(s) 508 can be stride-1 convolutional layer(s).

The one or more level reduction layers 508 can each be configured to reduce the number of discretization levels based at least in part on a scaling factor. In some implementations, the scaling factor may be one half. For instance, in some implementations, each of the level reduction layer(s) 508 can reduce a discretization level at the output of the layer to half of the discretization level at the input of the layer. For example, if the input to the layer has a channel with 128 discretization levels, the output may have 64 discretization levels for the channel. Other suitable scaling factors to reduce the discretization level may be employed in accordance with example aspects of the present disclosure. In some implementations, each level reduction layer 508 may have a same scaling factor (e.g., one half). Additionally and/or alternatively, in some implementations, a first level reduction layer 508 can have a first scaling factor and a second level reduction layer 508 can have a second scaling factor that is different from the first scaling factor.

As one example, the discretization level can be reduced at each level reduction layer 508 by a discretized activation function having a plurality of activation levels corresponding to the desired amount of discretization levels at the layer. For instance, in some implementations, the level reduction layer(s) 508 can each include a discretized activation function having a plurality of activation levels that corresponds to a reduced number of discretization levels from a prior layer. In some implementations, each level reduction layer 508 can have a discretized activation function having a number of activation levels that is half that of a prior layer (e.g., an immediately prior layer). In some implementations, the discretized activation function can be a discretized tanh function. For example, the discretized tanh function can be discretized to a discrete plurality of outputs for any given input.

In some implementations, the activation functions in at least the level reduction layer(s) 508 can be ignored during backpropagation of the discretization level reduction model 500. For instance, the activation functions may be utilized during forward propagation and/or inference, but may be unaffected during a backpropagation step. For example, the activation functions may not be modified during training.

According to example aspects of the present disclosure, discretization level reduction model 500 can include any suitable number of level reduction layer(s) 508. For instance, the number of level reduction layer(s) 508 can be based at least in part on a desired number of discretization levels at the output layer 510 and/or a scaling factor by which each level reduction layer 508 reduces the number of discretization levels. For example, one example implementation includes seven level reduction layers 508 that each reduce a number of discretization levels at the output to half that at the input. For example, the example implementation can be configured to reduce input data having 256 discretization levels to binarized output data having two discretization levels. As another example, if the output data is desired to have four discretization levels, only five level reduction layer 508s, each reducing a number of discretization levels to half of the input levels, can be included.

According to example aspects of the present disclosure, discretization level reduction model 500 can include an output layer 510 configured to provide the level-reduced tensor data. For example, the output layer 510 can provide the level-reduced tensor data as an output of the discretization level reduction model 500 (e.g., an image). In some implementations, the output layer 510 can additionally be a final level reduction layer 508. For example, the output layer 510 can reduce input from a next-to-final level reduction layer 508 to output data having a desired number of discretization levels in addition to providing the output data as output of the discretization level reduction model 500. As another example, the output layer 510 can be a final level reduction layer 508 configured to reduce a number of discretization levels of an input to the output layer 510 to the reduced number of discretization levels of the level-reduced tensor data. In some implementations, the reduced number of discretization levels of the level-reduced tensor data can be two discretization levels (e.g., 0 and 1). In some implementations, the output layer 510 includes a spatial component (e.g., an image of M×N binary pixels), such the representation found in the output layer 510 can be returned directly as an image, such as without any further transformations or other modifications.

Additionally and/or alternatively, the machine-learned discretization level reduction model 500 can include one or more reconstruction layer(s) 512. The reconstruction layer(s) 512 can be subsequent to the output layer 510. For instance, the reconstruction layer(s) 512 can attempt to reconstruct the input tensor data from the level-reduced tensor data. As one example, a reconstruction output layer 514 (e.g., a final reconstruction layer) can provide the reconstructed input tensor data. In some implementations, the reconstruction layer(s) 512 can be structurally similar to and/or identical to the feature representation layer(s) 504. For instance, in some implementations, the reconstruction layer(s) 512 can be or can include convolutional layer(s), such as 3×3, 6×6, etc. convolutional layer(s) and/or stride-1 convolutional layer(s). The reconstruction layer(s) 512 can be used during at least training and/or may be unused during inference. For instance, the reconstruction layer(s) 512 may be omitted from deployed model 500 and/or included at deployed model 500, such as for tuning the model 500 after deployment. For example, the reconstructed input data may not be used or provided as output of the model 500.

Intuitively, including reconstruction layer(s) 512 for at least training can ensure that the model 500 learns to produce output tensor data that includes enough channel (e.g., color) and/or spatial information to accurately reconstruct the original tensor data (e.g., image). For instance, this can result in enough color information being included in the binary image (e.g., as learned binary patterns) that the color information can be perceived within the binary image itself. Thus, while the reconstruction layer(s) 512 may not be used in generating the final output of the machine-learned discretization level reduction model 500, they can provide improved generative capability of the model 500 when employed during a training step. This can be beneficial in cases where supervised training data is not readily available (e.g., suitable binarized images), as the model 500 can be trained in an unsupervised manner on only readily available input data (e.g., any suitable image).

In some implementations, dimensions of the tensor data can be preserved by the machine-learned discretization level reduction model 500. For example, some or all dimensions (e.g., length, width, height, etc.) of the input tensor data can be identical to corresponding dimensions of the level-reduced tensor data. For example, a binarized image produced by the machine-learned discretization level reduction model 500 may be the same visual size (e.g., width×height) as an input image.

The discretization level reduction model 500 can further include a color bypass network 522. The color bypass network 522 can pass image-wide information (e.g., color information) past some or all layers of the discretization level reduction model 500. For instance, the color bypass network 522 can pass image-wide information such as hue and/or color information to provide for reconstruction of a color bypass reconstruction at color bypass reconstruction layer 524 that is separate from the reconstruction generated by the reconstruction layer(s) 512 (e.g., at reconstruction output layer 514). The color bypass network 522 can include one or more hidden units. In some implementations, the color bypass network 522 can be fully connected to a layer of the discretization level reduction model 500, such as, for example, the input layer 502. For example, the color bypass network 522 can include one or more fully connected hidden units that are fully connected to the input layer 502. For instance, including fully connected hidden units can allow the hidden units to capture image-wide information. In implementations where the layers of the discretization level reduction model 500 are convolutional layers, this can provide that the layers (e.g., feature representation layer(s), level reduction layer(s), etc.) can capture localized spatial information while the color bypass network 522 can capture image-wide information, such as tint, hue, etc. As one example, the color bypass network can capture overall brightness or overall shading effects in general—e.g. capturing the upper right corner is brightest and lower-left is darkest.

Intuitively, including a color bypass network 522 can provide for image-wide information such as tint, hue, etc. to be passed to a color bypass reconstruction at color bypass reconstruction output layer 524. This provides that it is not necessary to capture this information, which may not be useful in a level-reduced representation (e.g., as the level-reduced representation may lack, for example, color channels), at the level-reduced tensor data at output data 206. Rather, this information is passed through a supplementary color bypass network 522, providing for the level-reduced tensor data to include (e.g., by virtue of convolutional layers, in some implementations) increased localized spatial/boundary information, which can be useful for providing level-reduced tensor data with improved spatial (e.g., visual) information. However, by passing this information through the color bypass network 522, it can be utilized for training the model 500. For example, the reconstruction from the reconstruction layers 512 and/or 514, as a first reconstructed input tensor data component, can be combined with the color bypass reconstruction from color bypass reconstruction output layer 524, as a second reconstructed input tensor data component, to reconstruct the reconstructed input tensor data. The model 500 can then be trained on this reconstructed input tensor data (e.g., as opposed to the reconstruction from the reconstruction layers 512 and/or 514 directly). As one example, the components 514 and 524 can be combined by pixel-level addition, such as by being added together pixel-by-pixel.

Generally, it is desirable that the color bypass network 522 include enough hidden units to capture desirable image-wide information, but not so large that the color bypass network 522 will capture localized information, which can prevent that information from being included at the level-reduced tensor data. Thus, in some implementations, the color bypass network 522 can include between one and ten hidden units, such as one and ten fully connected hidden units. For instance, in some implementations, the color bypass network 522 can include two hidden units. Intuitively, these two hidden units can capture information related to a dimension of the image, such as a width-directed color gradient and/or a height-directed color gradient, although this is described for the purposes of illustration only, and the hidden units may capture any suitable image-wide information.

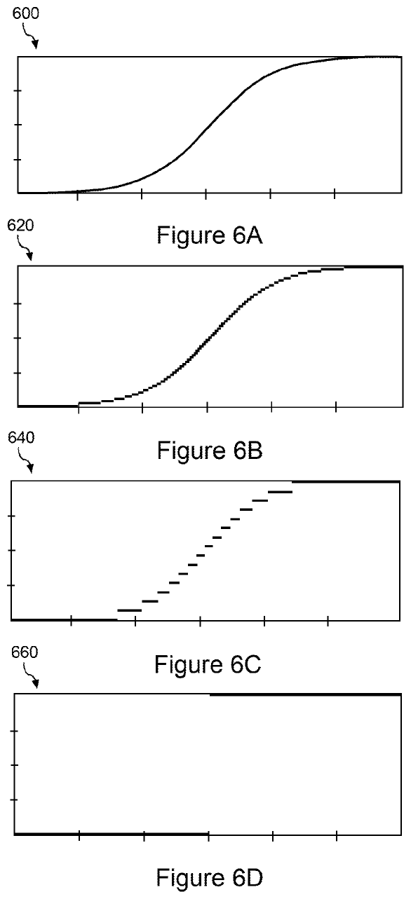

FIGS. 6A, 6B, 6C, and 6D depict example discretized activation functions 600, 620, 640, and 660 according to example implementations of the present disclosure. For instance, the discretized activation functions 600, 620, 640, 660 are discretized tanh functions having decreasing numbers of activation levels (e.g., corresponding to decreasing discretization levels). As one example, the discretized activation function 600 includes 256 activation levels capable of producing layer output having 256 discretization levels. For example, input to a layer including function 600 will be used as input to the function 600 and mapped to an output of the function as a value retained at the layer. For example, if the input tensor data has 256 discretization levels, such as input image data having 8 bits per channel per pixel, the activation function 600 may be included at a first level reduction layer. Similarly, FIG. 6B depicts a discretized activation function 620 having 64 activation levels, corresponding to 64 discretization levels. The activation function 620 may be included at a level reduction layer producing output having 64 discretization levels, such as a third level reduction layer (e.g., in implementations where each level reduction layer reduces a number of discretization levels to half an input number). Similarly, FIG. 6C depicts a discretized activation function 640 having 16 activation levels, corresponding to 16 discretization levels. As depicted in FIGS. 6A through 6C, the decreasing number of activation levels generally corresponds to decreased granularity of the output data, which can provide for less information to be conveyed by data while decreasing requirements to store, transmit, and/or interpret the data. Finally, FIG. 6D depicts an activation function 660 only having two discretization levels, 0 and 1. For instance, activation function 660 may be included as an activation function at an output layer and/or a final level reduction layer to provide binarized output.

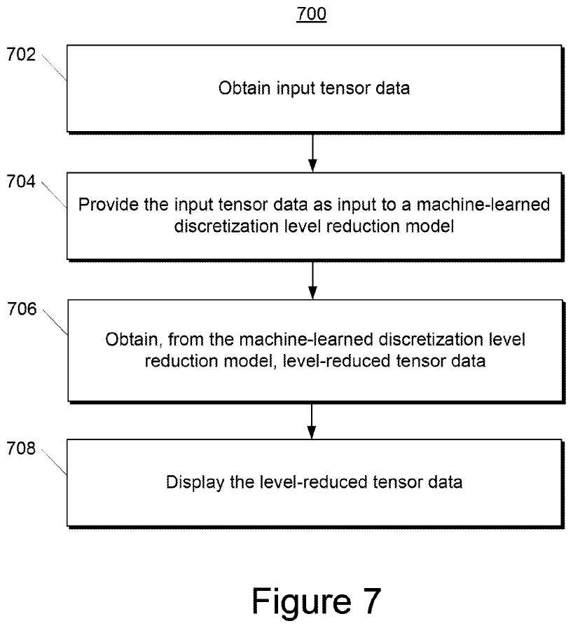

FIG. 7 depicts a flow chart diagram of an example computer-implemented method 700 for providing level-reduced tensor data having improved representation of (e.g., spatial) information according to example implementations of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

The computer-implemented method 700 can include, at 702, obtaining (e.g., by a computing system) input tensor data. For instance, the input tensor data can be obtained from a user, such as in response to a user performing a file upload or file transfer action. As another example, the input tensor data can be received from a separate computing system. In some implementations, the input tensor data can be or can include image data, such as a full-color image.

The computer-implemented method 700 can include, at 704, providing (e.g., by the computing system) the input tensor data as input to a machine-learned discretization level reduction model. The discretization level reduction model can be configured to receive tensor data having a number of discretization levels and produce, in response to receiving the tensor data, level-reduced tensor data having a reduced number of discretization levels.

The computer-implemented method 700 can include, at 706, obtaining (e.g., by the computing system), from the machine-learned discretization level reduction model, level-reduced tensor data. For instance, the model can provide the level-reduced tensor data as output of the model. The level-reduced tensor data can have a reduced number of discretization levels from the input tensor data.

The computer-implemented method 700 can include, at 708, displaying (e.g., by the computing system), the level-reduced tensor data. For example, the level-reduced tensor data can be displayed (e.g., as an image), provided to a printer, construction machine, or other suitable device, and/or otherwise displayed to a user.

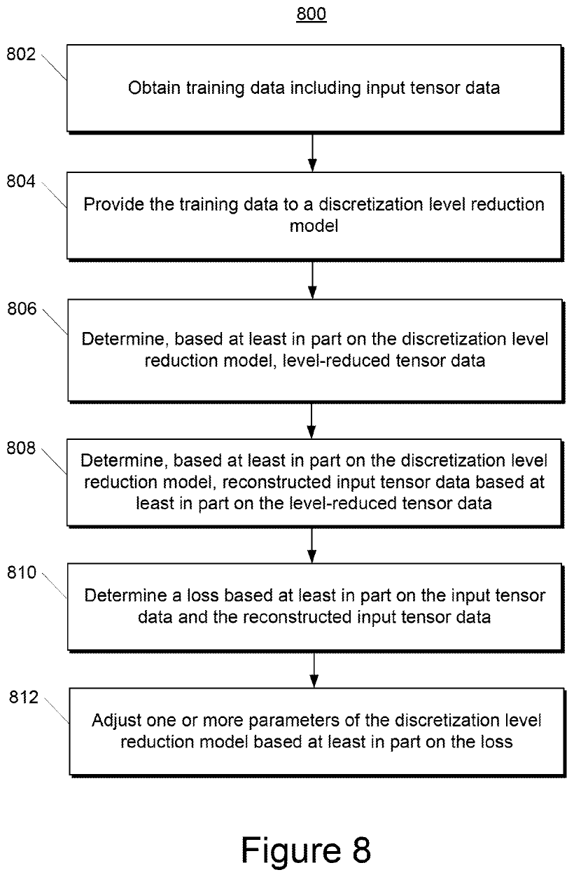

FIG. 8 depicts a flow chart diagram of an example computer-implemented method 800 for training a discretization level reduction model to provide level-reduced tensor data having improved representation of (e.g., spatial) information according to example implementations of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

The computer-implemented method 800 can include, at 802, obtaining (e.g., by a computing system including one or more computing devices) training data. The training data can be any suitable training data used to train the discretization level reduction model. For instance, the training data can include input tensor data. In many cases, it can be difficult or impossible to prepare supervised training data (e.g., pairs of input and desired output data) and, as such, the systems and methods described herein can provide for unsupervised training. For example, the training data may include only input data, such as a corpus of images.

The computer-implemented method 800 can include, at 804, providing (e.g., by the computing system) the training data to a discretization level reduction model. The discretization level reduction model can be configured to receive tensor data having a number of discretization levels and produce, in response to receiving the tensor data, level-reduced tensor data having a reduced number of discretization levels.

The discretization level reduction model can be any suitable discretization level reduction model according to example aspects of the present disclosure. For instance, in some implementations, the discretization level reduction model can include at least one input layer configured to receive the input tensor data. Additionally and/or alternatively, in some implementations, the discretization level reduction model can include an output layer configured to provide the level-reduced tensor data. Additionally and/or alternatively, in some implementations, the discretization level reduction model can include one or more level reduction layers connecting the at least one input layer to the output layer. The one or more level reduction layers can be configured to reduce a number of discretization levels at each of the one or more level reduction layers. Additionally and/or alternatively, in some implementations, the discretization level reduction model can include one or more reconstruction layers configured to reconstruct the reconstructed input tensor data from the level-reduced tensor data. Furthermore, in some implementations, the discretization level reduction model can include a color bypass network, such as a color bypass network including one or more fully connected hidden units, such as from one to ten hidden units, such as two hidden units.

The computer-implemented method 800 can include, at 806, determining (e.g., by the computing system), based at least in part on the discretization level reduction model, the level-reduced tensor data. For instance, the level-reduced tensor data can be determined by the discretization level reduction model, such as by an output layer of the discretization level reduction model. The level-reduced tensor data may be provided as output and/or may be propagated for training the model (e.g., with or without being provided as output). In some implementations, the level-reduced tensor data can be or can include a binarized image generated from an input image of the training data. For example, in some implementations, the input tensor data can be or can include image data. Additionally and/or alternatively, the level-reduced tensor data can be or can include binarized image data. As one example, the level-reduced tensor data can be determined by providing the input tensor data to a discretization level reduction model including, for example, input layer(s), feature representation layer(s), channel reduction layer(s), level reduction layer(s), and/or output layer(s).

The computer-implemented method 800 can include, at 808, determining (e.g., by the computing system), based at least in part on the discretization level reduction model, reconstructed input tensor data based at least in part on the level-reduced tensor data. For instance, the reconstructed input tensor data can be reconstructed from at least the level-reduced tensor data, such as by reconstruction layer(s) of the discretization level reduction model. The reconstructed input tensor data can resemble the input tensor data. For instance, the reconstructed input tensor data can include a greater amount of information and/or information in a more easily perceived manner than the level-reduced tensor data, including information that is extrapolated from the level-reduced tensor data to recreate the input tensor data. Generally, it is desirable for the reconstructed input tensor data to be as close to the input tensor data as possible while conforming to the structure of the discretization level reduction model. In this way, the model can learn to provide sufficient spatial information at the level-reduced tensor data to closely reconstruct the input tensor data.

In some implementations, such as implementations where the discretization level reduction model includes a color bypass network, determining the reconstructed input tensor data can be based at least in part on the level-reduced tensor data and a color bypass reconstruction. For instance, in some implementations, determining the reconstructed input tensor data can include obtaining (e.g., by the computing system) a first reconstructed input tensor data component. The first reconstructed input tensor data component can be obtained from the one or more reconstruction layers. The first reconstructed input tensor data component can be based at least in part on the level-reduced tensor data. For example, the first reconstructed input tensor data component can be (e.g., intermediate) reconstructed input tensor data that is produced by the reconstruction layers from the level-reduced tensor data. As one example, the first reconstructed input tensor data component can be a reconstructed image (e.g., a full-color image) that approximates an input image. For example, the reconstructed image can have a same number of channels and/or discretization levels as the input image. According to example aspects of the present disclosure, this image can be made to more closely approximate the input image by including information from the color bypass network.

Additionally and/or alternatively, in some implementations, determining the reconstructed input tensor data can include obtaining (e.g., by the computing system) a second reconstructed input tensor data component. The second reconstructed input tensor data component can be obtained from the color bypass network. For instance, in some implementations, the second reconstructed input tensor data can be a color bypass reconstruction. For example, the second reconstructed input tensor data component can be obtained from a color bypass reconstruction layer that is included in and/or otherwise connected to the color bypass network. The second reconstructed input tensor data component can be based at least in part on the input tensor data. For example, in some implementations, the second reconstructed input tensor data component can be obtained based at least in part on a color bypass network that is connected to (e.g., fully connected to, such as by including at least one fully connected hidden unit), an input layer including the input tensor data. In some implementations, the second reconstructed input tensor data component may be a reconstructed image based on an input image. The second reconstructed input tensor component may be a reconstructed image that includes less localized spatial information than a reconstructed image of the first reconstructed input tensor data component. For example, the second reconstructed input tensor data component can be a color tint for the reconstructed image, such as one or more gradients, etc.

Additionally and/or alternatively, in some implementations, determining the reconstructed input tensor data can include determining (e.g., by the computing system) the reconstructed input tensor data based at least in part on the first reconstructed input tensor data component and the second reconstructed input data component. For instance, in some implementations, the reconstructed input tensor data can be determined based at least in part on a pixel-wise combination of the first reconstructed input tensor data component and the second reconstructed input data component.

The computer-implemented method 800 can include, at 810, determining (e.g., by the computing system) a loss based at least in part on the input tensor data and the reconstructed input tensor data. For instance, in some implementations, the loss can be or can include a pixel-wise difference between the input tensor data and the reconstructed input tensor data. For example, the loss can convey a difference between the input tensor data and the reconstructed input data. The loss may include or otherwise define one or more gradients, such as gradients with respect to parameters of the discretization level reduction model. In some implementations, the reconstructed input data can be produced using only the level-reduced tensor data and/or (in some implementations) color bypass network information, which can intuitively provide that the model is trained to include information required to reconstruct the input tensor data in the level-reduced tensor data.

The computer-implemented method 800 can include, at 812, adjusting (e.g., by the computing system) one or more parameters of the discretization level reduction model based at least in part on the loss. The discretization level reduction model can include one or more parameters such as, for example, node and/or link weights, kernel weights, activation values or levels, etc. of the layer(s), such as the input layer(s), feature representation layer(s), channel reduction layer(s), level reduction layer(s), output layer(s), reconstruction layer(s), etc., and/or the color bypass network, and/or other portions of the discretization level reduction model. These parameters can be adjusted based on the loss, such as based on a gradient of the loss. For example, the loss (e.g., gradient of the loss) can be backpropagated through the discretization level reduction model to adjust parameters of the model and thereby train the model. In some implementations, the activation values or levels of a discretized activation function, such as a discretized tanh activation function, may be unchanged during training. For instance, as the discretized activation function is defined to discretize inputs, it may be unnecessary to shift, scale, or otherwise modify the activation function during training. Thus, the activation levels of the discretized activation function may be ignored during a backpropagation step, which can contribute to ease of training the model.

In at least this manner, the discretization level reduction model can be trained to produce level-reduced tensor data that includes enough information to reconstruct sufficiently accurate reconstructed input tensor data. This can provide for level-reduced tensor data that includes sufficient amounts of spatial information, which can translate into improved viewability and/or usability of, for example, images of the level-reduced tensor data, among various other uses. Furthermore, the systems and methods described herein can provide for training a discretization level reduction model even in cases where sufficient volumes of supervised training data are difficult and/or impossible to produce. For example, the model can be trained (e.g., only) using readily-available images while requiring few to no modifications on the images.

Intuitively, the machine-learned discretization level reduction model can learn to map colors of a full-color image into different binary or other level-reduced hashes or textures. The model can also intuitively learn “texture mappings” that visually reflect their source colors by virtue of being similar in cases of similar colors. This behavior is not explicitly defined, and is in fact an unexpected result of configuring a machine-learned model in such a manner as described according to example aspects of the present disclosure. This behavior can provide for generation of level-reduced images that can better capture visual or other spatial information and thus improve usability of the images.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example implementations thereof, each example is provided by way of explanation, not limitation of the disclosure. Those skilled in the art, upon attaining an understanding of the foregoing, can readily produce alterations to, variations of, and equivalents to such implementations. Accordingly, the subject disclosure does not preclude inclusion of such modifications, variations and/or additions to the present subject matter as would be readily apparent to one of ordinary skill in the art. For instance, features illustrated or described as part of one implementation can be used with another implementation to yield a still further implementation. Thus, it is intended that the present disclosure cover such alterations, variations, and equivalents.

1. A computer-implemented method for providing level-reduced tensor data having improved representation of information, the method comprising:
obtaining input tensor data;
providing the input tensor data as input to a machine-learned discretization level reduction model configured to receive tensor data comprising a number of discretization levels and produce, in response to receiving the tensor data, level-reduced tensor data comprising a reduced number of discretization levels, wherein the machine-learned discretization level reduction model comprises:
at least one input layer configured to receive the tensor data; and
one or more level reduction layers connected to the at least one input layer, the one or more level reduction layers configured to receive input having a first number of discretization levels and to provide a layer output having a reduced a number of discretization levels;
wherein each level reduction layer is associated with a respective number of discretization levels and the discretization level is reduced at each layer of the one or more level reduction layers based at least in part on a discretized activation function having the respective number of discretization levels associated with the level reduction layer;
obtaining, from the machine-learned discretization level reduction model, the level-reduced tensor data;
wherein the machine-learned discretization level reduction model is trained using reconstructed input tensor data generated using an output of the machine-learned discretization level reduction model.

2. The method of claim 1, wherein the input tensor data comprises image data, and wherein the level-reduced tensor data comprises binarized image data.

3. The method of claim 1, wherein the discretization level reduction model further comprises at least one feature representation layer configured to map the input tensor data from the input layer to a feature representation of the input tensor data.

4. The method of claim 1, wherein the discretization level reduction model further comprises at least one channel reduction layer configured to reduce an input to the at least one channel reduction layer input data having a first number of channels to an output of the at least one channel reduction layer having a reduced number of channels.

5. The method of claim 1, wherein the one or more level reduction layers are each configured to reduce the number of discretization levels based at least in part on a scaling factor.

6. The method of claim 5, wherein the scaling factor is one half.

7. The method of claim 1, wherein the one or more level reduction layers progressively and monotonically reduce a number of discretization levels at each of the one or more level reduction layers.

8. The method of claim 1, wherein the discretized activation function is a discretized tanh function.

9. The method of claim 1, wherein the machine-learned discretization level reduction model comprises an output layer configured to provide the level-reduced tensor data.

10. The method of claim 1, wherein the reduced number of discretization levels of the level-reduced tensor data is two discretization levels.

11. The method of claim 1, wherein the discretization level reduction model comprises one or more reconstruction layers configured to reconstruct the reconstructed input tensor data from the level-reduced tensor data.

12. The method of claim 1, wherein the discretization level reduction model comprises a color bypass network, the color bypass network comprising one or more fully connected hidden units.

13. The method of claim 12, wherein the color bypass network comprises between one and ten fully connected hidden units.

14. A computer-implemented method for training a discretization level reduction model to provide level-reduced tensor data having improved representation of information, the computer-implemented method comprising:
obtaining, by a computing system comprising one or more computing devices, training data, the training data comprising input tensor data;
providing, by the computing system, the training data to a discretization level reduction model, the discretization level reduction model configured to receive tensor data comprising a number of discretization levels and produce, in response to receiving the tensor data, level-reduced tensor data comprising a reduced number of discretization levels;
determining, by the computing system and based at least in part on the discretization level reduction model, the level-reduced tensor data;
determining, by the computing system and based at least in part on the discretization level reduction model, reconstructed input tensor data based at least in part on the level-reduced tensor data;
determining, by the computing system, a loss based at least in part on the input tensor data and the reconstructed input tensor data; and
adjusting, by the computing system, one or more parameters of the discretization level reduction model based at least in part on the loss.

15. The computer-implemented method of claim 14, wherein the input tensor data comprises image data, and wherein the level-reduced tensor data comprises binarized image data.

16. The computer-implemented method of claim 14, wherein the loss comprises a pixel-wise difference between the input tensor data and the reconstructed input tensor data.

17. The computer-implemented method of claim 14, wherein the machine-learned discretization level reduction model comprises:
at least one input layer configured to receive the input tensor data;
one or more level reduction layers connected to the at least one input layer, the one or more level reduction layers configured to reduce a number of discretization levels at each of the one or more level reduction layers; and
one or more reconstruction layers configured to reconstruct the reconstructed input tensor data from the level-reduced tensor data.

18. The computer-implemented method of claim 17, wherein the discretization level reduction model comprises a color bypass network, the color bypass network comprising one or more fully connected hidden units, and wherein determining, by the computing system and based at least in part on the discretization level reduction model, reconstructed input tensor data based at least in part on the level-reduced tensor data comprises:
obtaining, by the computing system, a first reconstructed input tensor data component from the one or more reconstruction layers, the first reconstructed input tensor data component based at least in part on the level-reduced tensor data;
obtaining, by the computing system, a second reconstructed input tensor data component from the color bypass network, the second reconstructed input tensor data component based at least in part on the input tensor data; and
determining, by the computing system, the reconstructed input tensor data based at least in part on the first reconstructed input tensor data component and the second reconstructed input data component.

19. The computer-implemented method of claim 18, wherein the first reconstructed input tensor data component comprises a reconstructed image and wherein the second reconstructed input tensor data component comprises a color tint for the reconstructed image.

20. One or more non-transitory, computer-readable media storing a machine-learned discretization level reduction model configured to receive tensor data comprising a number of discretization levels and produce, in response to receiving the tensor data, level-reduced tensor data comprising a reduced number of discretization levels, wherein the machine-learned discretization level reduction model comprises:
at least one input layer configured to receive the tensor data; and
a plurality of level reduction layers connected to the at least one input layer, the plurality of level reduction layers configured to progressively and monotonically reduce a number of discretization levels at each of the plurality of level reduction layers.
